(19) United States
(12) Patent Application Publication
(10) Pub. No.: US 2023/0186382 A1
(43) Pub. Date: Jun. 15, 2023

(54) System, Method and Apparatus for Providing Improved Electronic Disclosure of Credit Terms

(71) Applicant: Affirm, Inc., San Francisco, CA (US)

(72) Inventors: Laurie Sellick, San Francisco, CA (US); Krista Potter, San Francisco, CA (US)

(21) Appl. No.: 17/546,292

(22) Filed: Dec. 9, 2021

(51) Int. Cl. G06Q 40/02; G06Q 20/40; G06Q 20/24; G06Q 20/10

(52) U.S. Cl. CPC G06Q 40/025; G06Q 20/40; G06Q 20/24; G06Q 20/102

(57) ABSTRACT

A method for providing an interface to a user in relation to extension of a loan to the user may include receiving user information associated with the user and transaction information associated with a transaction of the user with respect to a product or service offered by a vendor. The method may further include, responsive to a credit extension decision with respect to a financing option based on the user information and the transaction information, generating one or more credit offers to present to the user, and, responsive to user selection of a selected credit offer, generating a composite disclosure comprising a first section including payment details for pay back of a loan associated with the selected credit offer and a second section including legal or required disclosure materials associated with the selected credit offer.

### TECHNICAL FIELD

Example embodiments generally relate to financial industry technologies and, in particular, relate to apparatuses, systems, and methods for enabling an improved disclosure of credit terms during the process of checking a consumer out in relation to purchasing goods or services.

### BACKGROUND

The financial industry is comprised of many thousands of customers, vendors, lenders, borrowers, and other bit players that all interact in various ways to enable customers to ultimately have access to goods and services provided by the vendors. Credit and debit transactions have long been a way that individuals have managed point of sale transactions to ensure relatively seamless transfer of funds from customers, or on their behalf, to vendors for relatively routine or small transactions. Meanwhile, obtaining a loan from a bank has long been the most common way of obtaining financing for non-routine or larger transactions. More recently, buy now, pay later financing has become a popular option.

In many of cases, a customer may interact with a vendor or lender to work through a transaction that ultimately provides the vendor with the necessary funds to complete the transaction. When the transaction involves a lender, the lender will typically define a workflow for completing the transaction, which the customer will transit through. When some form of financing is to be employed in this way, the lender is often under various obligations to provide certain disclosures to the customer. In the past, the means by which these disclosures have been made have not been very user friendly, and can be confusing to the customer. Such confusion may lead to certain customers abandoning the effort to undertake the transaction, which may lead to customer and vendor dissatisfaction and effectively serves no one.

### BRIEF SUMMARY OF SOME EXAMPLES

Accordingly, some example embodiments may enable the provision of technical means by which to provide a foundation for enabling a more user friendly, efficient and straightforward checkout process.

In an example embodiment, a method for providing an interface to a user in relation to extension of a loan to the user may be provided. The method may include receiving user information associated with the user and transaction information associated with a transaction of the user with respect to a product or service offered by a vendor. The method may further include, responsive to a credit extension decision with respect to a financing option based on the user information and the transaction information, generating one or more credit offers to present to the user, and, responsive to user selection of a selected credit offer, generating a composite disclosure comprising a first section including payment details for pay back of a loan associated with the selected credit offer and a second section including legal or required disclosure materials associated with the selected credit offer.

In another example embodiment, an apparatus for providing an interface to a user in relation to extension of a loan may be provided. The apparatus may include processing circuitry configured for receiving user information associated with the user and transaction information associated with a transaction of the user with respect to a product or service offered by a vendor. The processing circuitry may further be configured for, responsive to a credit extension decision with respect to a financing option based on the user information and the transaction information, generating one or more credit offers to present to the user, and, responsive to user selection of a selected credit offer, generating a composite disclosure comprising a first section including payment details for pay back of a loan associated with the selected credit offer and a second section including legal or required disclosure materials associated with the selected credit offer.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a functional block diagram of a system for extending credit for financial transactions at checkout according to an example embodiment;

FIG. 2 illustrates a functional block diagram of a client according to an example embodiment;

FIG. 3 illustrates a block diagram showing control flow associated with operation of a credit extension platform and interface generation module in accordance with an example embodiment;

FIG. 4 illustrates a block diagram showing credit system interactions in accordance with an example embodiment;

FIG. 5 illustrates separate screens used for presenting truth in lending disclosures and payment plan details in accordance with an example embodiment;

FIG. 6 illustrates a composite disclosure used for presenting truth in lending disclosures and payment plan details in one common interface in accordance with an example embodiment;

FIG. 7 illustrates a detailed view of a truth in lending disclosure in accordance with an example embodiment;

FIG. 8 illustrates the composite disclosure expanded for automatic payment interface in accordance with an example embodiment;

FIG. 9 illustrates the composite disclosure expanded for submission of a down payment in accordance with an example embodiment;

FIG. 10 illustrates an interface for exploring early payment options in accordance with an example embodiment; and

FIG. 11 is a block diagram of a method according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other. Additionally, when the term “data” is used, it should be appreciated that the data may in some cases include simply data or a particular type of data generated based on operation of algorithms and computational services, or, in some cases, the data may actually provide computations, results, algorithms and/or the like that are provided as services.

As used in herein, the term “module” is intended to include a computer-related entity, such as but not limited to hardware, firmware, or a combination of hardware and software (i.e., hardware being configured in a particular way by software being executed thereon). For example, a module may be, but is not limited to being, a process running on a processor, a processor (or processors), an object, an executable, a thread of execution, and/or a computer. By way of example, both an application running on a computing device and/or the computing device can be a module. One or more modules can reside within a process and/or thread of execution and a module may be localized on one computer and/or distributed between two or more computers. In addition, these components can execute from various computer readable media having various data structures stored thereon. The modules may communicate by way of local and/or remote processes such as in accordance with a signal having one or more data packets, such as data from one module interacting with another module in a local system, distributed system, and/or across a network such as the Internet with other systems by way of the signal. Each respective module may perform one or more functions that will be described in greater detail herein. However, it should be appreciated that although this example is described in terms of separate modules corresponding to various functions performed, some examples may not necessarily utilize modular architectures for employment of the respective different functions. Thus, for example, code may be shared between different modules, or the processing circuitry itself may be configured to perform all of the functions described as being associated with the modules described herein. Furthermore, in the context of this disclosure, the term “module” should not be understood as a nonce word to identify any generic means for performing functionalities of the respective modules. Instead, the term “module” should be understood to be a modular component that is specifically configured in, or can be operably coupled to, the processing circuitry to modify the behavior and/or capability of the processing circuitry based on the hardware and/or software that is added to or otherwise operably coupled to the processing circuitry to configure the processing circuitry accordingly.

As noted above, the typical workflow for customer checkout, particularly when a financing option is employed, will necessarily include certain disclosures regarding financing terms and conditions. These disclosures may include a truth in lending disclosure or other information that may be required in some cases. Presentation of such information within the course of the workflow for customer checkout in a simple and straightforward way may be more likely to ensure that transactions are completed, and introduce less opportunity for confusion and customer dissatisfaction. Thus, example embodiments may provide a technical solution to ensure that key terms of a truth in lending statement, or other information disclosures that are integrated into the checkout workflow, are easily understood by the customer, particularly when viewing such information on a mobile device. In this regard, mobile devices have limited screen space, and therefore have limitations with respect to what can be presented and consumed or understood on any given screen or page. Thus, providing information and/or disclosures in accordance with an example embodiment may balance the spatial limitations of mobile device screens with the need for an easy way to present a sizeable amount of desirable or required information.

Some example embodiments described herein provide for a credit extension platform with improved workflow for checkout that can be instantiated at an apparatus comprising configurable processing circuitry. The processing circuitry may be configured to execute various processing functions on financial data using the techniques described herein. The credit extension platform may, for example, be configured to provide a way to proceed to checkout in more coherent yet simple way that gives customers greater confidence and comfortability with the workflow associated with selection and implementation of financing options. The increased simplicity and straightforwardness provided to customers may translate into more access to credit, more active customers, and better conversion rates for vendors.

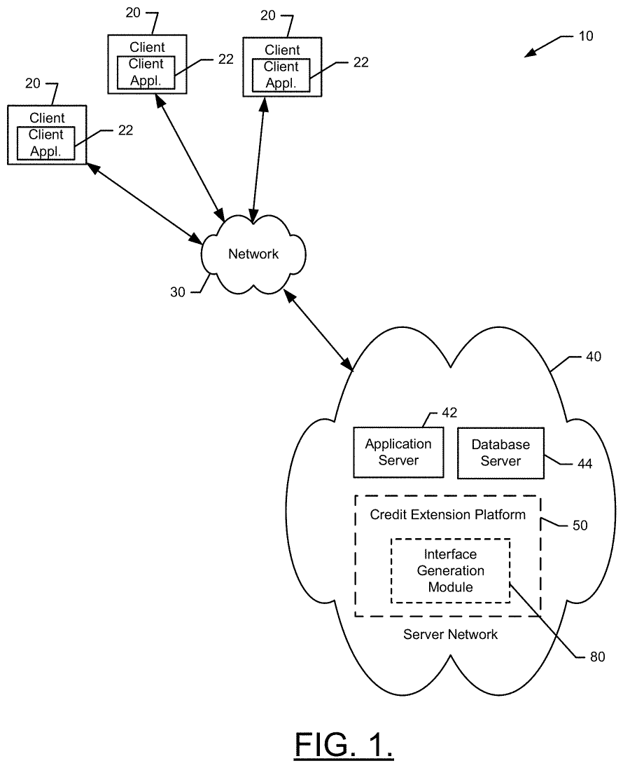

Example embodiments may be employed in connection with making underwriting decisions at checkout or time of purchase though at least some of the interface generation involved in example embodiments may also occur during the process leading up to checkout. An example embodiment of the invention will now be described in reference to FIG. 1, which illustrates an example system in which an embodiment of the present invention may be employed. As shown in FIG. 1, a credit management system 10 according to an example embodiment may include one or more client devices (e.g., clients 20). Notably, although FIG. 1 illustrates three clients 20, it should be appreciated that a single client or many more clients 20 may be included in some embodiments and thus, the three clients 20 of FIG. 1 are simply used to illustrate a potential for a multiplicity of clients 20 and the number of clients 20 is in no way limiting to other example embodiments. In this regard, example embodiments are scalable to inclusion of any number of clients 20 being tied into the system 10. Furthermore, in some cases, some embodiments may be practiced on a single client without any connection to the system 10.

The clients 20 may, in some cases, each be associated with a single computer or computing device that is capable of executing software programmed to implement example embodiments. Thus, in some embodiments, one or more of the clients 20 may be associated with an organization (e.g., a vendor company) and may be located in different business units, branch offices, or other locations. In other cases, the clients 20 may be associated with individual users (i.e., customers) that may wish to interact with other clients 20 and/or a financial institution or entity. In general, the clients 20 may be terminals or platform entities that are capable of executing example embodiments, and there could be as few as one, or a host of such terminals or entities.

Each one of the clients 20 may include one or more instances of a communication device such as, for example, a computing device (e.g., a computer, a server, a network access terminal, a personal digital assistant (PDA), radio equipment, cellular phone, smart phone, or the like) capable of communication with a network 30. As such, for example, each one of the clients 20 may include (or otherwise have access to) memory for storing instructions or applications for the performance of various functions and a corresponding processor for executing stored instructions or applications. Each one of the clients 20 may also include software and/or corresponding hardware for enabling the performance of the respective functions of the clients 20 as described below. In an example embodiment, the clients 20 may include or be capable of executing a client application 22 configured to operate in accordance with an example embodiment of the present invention. In this regard, for example, the client application 22 may include software for enabling a respective one of the clients 20 to communicate with the network 30 for requesting and/or receiving information and/or services via the network 30 as described herein. The information or services receivable at the client applications 22 may include deliverable components (e.g., downloadable software to configure the clients 20, or information for consumption/processing at the clients 20). As such, for example, the client application 22 may include corresponding executable instructions for configuring the client 20 to provide corresponding functionalities for sharing, processing and/or utilizing financial data as described in greater detail below.

The network 30 may be a data network, such as one or more instances of a local area network (LAN), a metropolitan area network (MAN), a wide area network (WAN) (e.g., the Internet), and/or the like, which may couple the clients 20 to devices such as processing elements (e.g., personal computers, server computers or the like) and/or databases. Communication between the network 30, the clients 20 and the devices or databases (e.g., servers) to which the clients 20 are coupled may be accomplished by either wireline or wireless communication mechanisms and corresponding communication protocols.

In an example embodiment, devices to which the clients 20 may be coupled via the network 30 may include one or more application servers (e.g., application server 42), and/or a database server 44, which together may form respective elements of a server network 40. Although the application server 42 and the database server 44 are each referred to as “servers,” this does not necessarily imply that they are embodied on separate servers or devices. As such, for example, a single server or device may include both entities and the database server 44 could merely be represented by a database or group of databases physically located on the same server or device as the application server 42. The application server 42 and the database server 44 may include hardware and/or software for configuring the application server 42 and the database server 44, respectively, to perform various functions. As such, for example, the application server 42 may include processing logic and memory enabling the application server 42 to access and/or execute stored computer readable instructions for performing various functions.

In an example embodiment, one function that may be provided by the application server 42 may be the provision of access to information and/or services related to credit extension platform 50, and more particularly relating to facilitating financial computations and calculations related to decisions associated with extensions of credit (e.g., loans where, for example, the loans may include a buy now, pay later loan, or other products associated with credit or lending transactions). For example, the application server 42 may be configured to provide (via the credit extension platform 50) execution of instructions, and storage of information descriptive of events or activities, associated with the credit extension platform 50 and the execution of a financial computations, calculations and modeling on behalf of a user of the system 10 located at one of the clients 20, or interacting with a user located at one of the clients 20, in real time. In some cases, the financial transaction may include obtaining buy now, pay later financing, and the activities associated therewith may include the provision of a loan/product application detailing information required by the lender (and operator of the credit extension platform 50) to determine whether credit, funds, or other products can be provided to the customer based on information provided in the loan/product application. However, example embodiments may also apply to other types of loans.

In some embodiments, the credit extension platform 50 may be a technical device, component or module affiliated with the lender or an agent of the lender. Thus, the credit extension platform 50 may operate under control of the lender or agent of the lender to be a technical means by which to carry out activities under direction of the lender/agent or employees thereof. As such, in some embodiments, the clients 20 may access the credit extension platform 50 services, and more particularly contact the credit extension platform 50 online and utilize the services provided thereby. However, it should be appreciated that in other embodiments, an application (e.g., the client application 22) enabling the clients 20 to interact with the credit extension platform 50 (or components thereof) may be provided from the application server 42 (e.g., via download over the network 30) to one or more of the clients 20 to enable recipient clients 20 to instantiate an instance of the client application 22 for local operation such that the credit extension platform 50 may be a distributor of software enabling individual users to utilize the credit extension platform 50. Alternatively, another distributor of the software may provide the client 20 with the client application 22, and the credit extension platform 50 may communicate with the client 20 (via the client application 22) after such download.

In an example embodiment, the client application 22 may therefore include application programming interfaces (APIs) and other web interfaces to enable the client 20 to conduct operations as described herein via the credit extension platform 50. The client application 22 may include a series of control consoles or web pages including a landing page, onboarding services, activity feed, account settings (e.g., user profile information), transaction management services, payment management services and the like in cooperation with a service application that may be executed at the credit extension platform 50. Thus, for example, the client application 22 may enable the user or operator to articulate and submit queries, make credit extension requests, initiate and pay for transactions using funds associated with a credit extension request, and/or the like using the credit extension platform 50.

In an example embodiment, the application server 42 may include or have access to memory (e.g., internal memory or the database server 44) for storing instructions or applications for the performance of various functions and a corresponding processor for executing stored instructions or applications. For example, the memory may store an instance of the credit extension platform 50 configured to operate in accordance with an example embodiment of the present invention. In this regard, for example, the credit extension platform 50 may include software for enabling the application server 42 to communicate with the network 30 and/or the clients 20 for the provision and/or receipt of information associated with performing activities as described herein. Moreover, in some embodiments, the application server 42 may include or otherwise be in communication with an access terminal such as any one of the clients 20 (e.g., a computer including a user interface) via which individual operators or managers of the entity associated with the facilitation agent may interact with, configure or otherwise maintain the credit extension platform 50. Thus, it should be appreciated that the functions of the credit extension platform 50 can be conducted via client-server based interactions involving communications between clients 20 and the server network 40, or may be conducted locally at one of the clients 20 after an instance of the credit extension platform 50 is downloaded (e.g., via or as the client application 22) locally at the corresponding one of the clients 20.

As such, the environment of FIG. 1 illustrates an example in which provision of content and information associated with the financial industry may be accomplished by a particular entity (namely the credit extension platform 50 residing at the application server 42 or at one of the clients 20). Thus, the credit extension platform 50 may be configured to handle provision of content and information that are secured as appropriate for the individuals or organizations involved and credentials of individuals or organizations attempting to utilize the tools provided herein may be managed by digital rights management services or other authentication and security services or protocols that are outside the scope of this disclosure.

As noted above, the credit extension platform 50 may operate to enable the user associated with a given one of the clients 20 to setup an account (i.e., a user account) with an entity that operates the credit extension platform 50. After account setup, the user may initiate transactions with various vendors and fund the transactions via credit extended by the entity (via the credit extension platform 50). Notably, account setup may occur prior to the user attempting to initiate any particular transaction, or may occur while the user is in the process of conducting a particular transaction. Thus, for example, the user may already have the user account prior to conducting transactions, or the user may setup the user account while conducting a transaction.

In an example embodiment, the credit extension platform 50 may enable the user to request an extension of credit in connection with a transaction where the type of financing option for which the extension of credit is to be requested is not specifically identified until the user has proceeded to checkout (e.g., at a virtual checkout in an online application). In some cases, the credit extension platform 50 of some example embodiments may conduct different and separate determinations regarding credit extension for corresponding different types of financing options that can be offered by the lender. In such cases, for example, one or more offers of credit (each potentially having different terms) may be provided to the user at checkout for each of the different types of financing options that are offered. As an example, prior to checkout, the credit extension platform 50 may make a determination as to the creditworthiness for any type of loan option that may be offered to the user. One or more credit offers for which the user is qualified may then be provided at checkout. The credit offers may differ by type (e.g., buy now, pay later vs. a standard loan at interest) or may simply be of the same type with different terms (e.g., payment amount, length of term, interest rate/finance charge, etc.). The user (i.e., the customer) may then select the credit offer (e.g., with any selectable terms) that is desired for completion of the transaction and proceed to checkout.

In some example embodiments, an interface generation module 80 may be provided to generate the interface screens that guide the user through the process of interacting with the credit extension platform 50 to obtain a credit extension decision regarding a financing option, select a financing or credit offer, and complete the transaction. However, as noted above, the interface generation module 80 of example embodiments may employ a unique and different strategy for displaying at least some of the information that is displayed in connection with these processes. In this regard, for example, a typical truth in lending disclosure may be provided on a separate page (or interface screen) from the page or pages that provide a review of details associated with any payment plan, and may also be provided in a different presentation paradigm. Meanwhile, example embodiments may provide all such information on a single page or interface screen using the same presentation paradigm.

In some cases, for example, the client application 22 may be used to engage (e.g., via a website and corresponding APIs generated via the interface generation module 80) with the credit extension platform 50 to select individual products, services, or the like that the user has an interest in purchasing in connection with an online transaction. The credit extension platform 50 may then be leveraged to perform the analysis described above to determine which credit offers to present to the user at checkout. At final checkout, the user may then be enabled to finalize the transaction. The credit extension platform 50 may prompt the client 20 to provide product details, information identifying the user (or a user account associated with the user) and/or other information associated with the financial transaction that is being evaluated. In other words, the client 20 (e.g., via the interface generation module 80) may provide a user interface function for interacting with the credit extension platform 50 to identify the information that will be evaluated using the credit extension platform 50. In this regard, a copy of the interface generation module 80 may be instantiated at the client 20, or the client 20 may utilize the services of the interface generation module 80 at the credit extension platform 50.

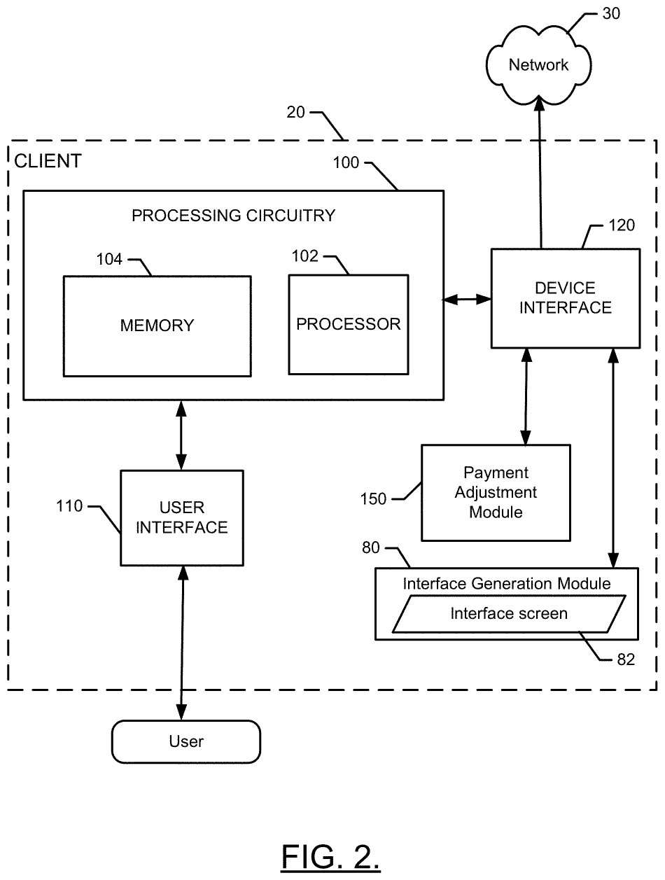

Regardless of how the queries, calculations or modeling activities are initiated, the credit extension platform 50 of FIG. 1 may be used to manage execution of such activities directly or indirectly. Each of these activities may have its own respective timing and calculations and communications that are facilitated by the credit extension platform 50 and various components of the credit extension platform 50 may be conducted in parallel. The components, which may be functional modules that operate via API or function calls to respective segmented platforms or a monolith or other collection of rules, policies, instructions, or the like. Some of the structures associated with the interface generation module 80 of an example embodiment will be described in reference to FIG. 2.

FIG. 2 shows certain elements of an apparatus for provision of a composite truth in lending and payment details disclosure according to an example embodiment. The apparatus of FIG. 2 may be employed, for example, as the credit extension platform 50 itself operating at, for example, a network device, server, proxy, or the like (e.g., the application server 42 of FIG. 1) or as the client 20 (which is shown in FIG. 2). However, it should be appreciated that example embodiments may be employed on a combination of devices (e.g., in distributed fashion on a device (e.g., a computer) or a variety of other devices/computers that are networked together). Accordingly, some embodiments of the present invention may be embodied wholly at a single device (e.g., the application server 42 or the client 20) or by devices in a client/server relationship (e.g., the application server 42 and one or more clients 20). Thus, although FIG. 2 illustrates the client 20 as including the components shown, it should be appreciated that some of the components may be distributed and not centrally located in some cases. Furthermore, it should be noted that the devices or elements described below may not be mandatory and thus some may be omitted or replaced with others in certain embodiments.

Referring now to FIG. 2, an apparatus for provision of tools, services and/or the like for facilitating presentation of interface screens to support decision making regarding extensions of credit in a simple and cogent manner is shown. In this regard, the credit extension platform 50 may be configured to perform analysis, modeling, or other determinations based on the signaling and/or the information provided to determine whether a financial transaction or loan can be underwritten according to one of at least two different types of financing options and, if so, what credit offers to extend to the user receiving an affirmative result in such determinations. The apparatus may be an embodiment of the credit extension platform 50 or client 20 or a device or component thereof including, for example, the interface generation module 80. As such, configuration of the apparatus as described herein may transform the apparatus into a version of the credit extension platform 50 or client 20 having the corresponding functionalities described herein.

In an example embodiment, the apparatus may include or otherwise be in communication with processing circuitry 100 that is configured to perform data processing, application execution and other processing and management services according to an example embodiment of the present invention. In one embodiment, the processing circuitry 100 may include a storage device (e.g., memory 104) and a processor 102 that may be in communication with or otherwise control a user interface 110 and a device interface 120. As such, the processing circuitry 100 may be embodied as a circuit chip (e.g., an integrated circuit chip) configured (e.g., with hardware, software or a combination of hardware and software) to perform operations described herein. However, in some embodiments, the processing circuitry 100 may be embodied as a portion of a server, computer, laptop, workstation or even one of various mobile computing devices. In some embodiments, the processor 102 may be embodied as a central processing unit (CPU) or a graphics processing unit (GPU). In situations where the processing circuitry 100 is embodied as a server or at a remotely located computing device, the user interface 110 may be disposed at another device (e.g., at a computer terminal) that may be in communication with the processing circuitry 110 via the device interface 120 and/or a network (e.g., network 30). Thus, in some cases, the connection of the user to the user interface 110 may actually occur via the network 30.

The user interface 110 may be in communication with the processing circuitry 100 to receive an indication of a user input at the user interface 110 and/or to provide an audible, visual, mechanical or other output to the user. As such, the user interface 110 may include, for example, a keyboard, a mouse, a joystick, a display, a touch screen, a microphone, a speaker, augmented/virtual reality device, or other input/output mechanisms. In embodiments where the apparatus is embodied at a server or other network entity, the user interface 110 may be remotely located relative to the user. In such cases, the user interface 110 may be located at one or all of the clients 20 of FIG. 1.

The device interface 120 may include one or more interface mechanisms for enabling communication with other components, devices and/or networks. In some cases, the device interface 120 may be any means such as a device or circuitry embodied in either hardware, software, or a combination of hardware and software that is configured to receive and/or transmit data from/to a network (e.g., network 30) and/or any other device or module in communication with the processing circuitry 100. In this regard, the device interface 120 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. In situations where the device interface 120 communicates with a network, the network 30 may be any of various examples of wireless or wired communication networks such as, for example, data networks like a Local Area Network (LAN), a Metropolitan Area Network (MAN), and/or a Wide Area Network (WAN), such as the Internet, as described above.

In an example embodiment, the memory 104 may include one or more non-transitory storage or memory devices such as, for example, volatile and/or non-volatile memory that may be either fixed or removable. The memory 104 may be configured to store information, data, applications, instructions or the like for enabling the apparatus to carry out various functions in accordance with example embodiments of the present invention. For example, the memory 104 could be configured to buffer input data for processing by the processor 102. Additionally or alternatively, the memory 104 could be configured to store instructions for execution by the processor 102. As yet another alternative, the memory 104 may include one of a plurality of databases (e.g., database server 44) that may store a variety of files, contents or data sets. Among the contents of the memory 104, applications (e.g., a service application configured to interface with the client application 22) may be stored for execution by the processor 102 in order to carry out the functionality associated with each respective application. For example, the memory 104 may store interface screen templates that define a basic structure for interface screens having corresponding functions or locations in a workflow. The interface screen templates may be populated with information specific to a given transaction or user.

The processor 102 may be embodied in a number of different ways. For example, the processor 102 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an example embodiment, the processor 102 may be configured to execute instructions stored in the memory 104 or otherwise accessible to the processor 102. As such, whether configured by hardware or software methods, or by a combination thereof, the processor 102 may represent an entity (e.g., physically embodied in circuitry) capable of performing operations according to embodiments of the present invention while configured accordingly. Thus, for example, when the processor 102 is embodied as an ASIC, FPGA or the like, the processor 102 may be specifically configured hardware for conducting the operations described herein. Alternatively, as another example, when the processor 102 is embodied as an executor of software instructions, the instructions may specifically configure the processor 102 to perform the operations described herein.

In an example embodiment, the processor 102 (or the processing circuitry 100) may be embodied as, include or otherwise control the interface generation module 80, which may be any means such as a device or circuitry operating in accordance with software or otherwise embodied in hardware or a combination of hardware and software (e.g., processor 102 operating under software control, the processor 102 embodied as an ASIC or FPGA specifically configured to perform the operations described herein, or a combination thereof) thereby configuring the device or circuitry to perform the corresponding functions of the interface generation module 80 as described below.

The interface generation module 80 may be configured to include tools to facilitate execution of a series of interface screens 82 based on the current location within a workflow associated with processing a transaction. The tools may be provided in the form of various modules (or submodules) that may be instantiated by configuration of the processing circuitry 100, and which may employ interface templates retrieved from the memory 104. The credit extension platform 50 may include tables, algorithms and/or the like that define decision making parameters regarding making credit offers and processing transactions based on the inputs provided thereto. The inputs may include credit limit information and/or other information identifying the user or customer (e.g., the applicant for credit), the goods involved, etc. In an example embodiment, the credit extension platform 50 may include a machine learning component programmed to take the inputs described above alone or with potentially other signals that may be used to balance risks associated with extending credit to a user in order to determine a form and structure of credit offers that are to be presented to the user. The credit offers may include any combination of financing option credit limits and/or credit offers. The credit extension platform 50 may utilize or otherwise communicate with the interface generation module 80 to enable the interface generation module 80 to provide the interface screens needed to navigate through the decision making process regarding extending credit offers, and the handling of acceptance of an offer, finally including also the completion of the transaction with the vendor.

In some embodiments, although not required, the processing circuitry 100 may also interface with, control or include a payment adjustment module 150, which may enable the user or customer to make proposed adjustments to credit offer terms. In this regard, for example, the payment adjustment module 150 may be configured to provide interfaces (e.g., via the interface generation module 80) specifically associated with modifying credit offer terms to update parameters associated with the credit offer in order to see how various modifications may alter different ones of the terms of the credit offer if the credit offer could be adjusted accordingly. For example, the payment adjustment module 150 may enable the user to explore how certain choices regarding repayment (e.g., paying early, paying extra, etc.) may impact interest paid, finance charges, payoff date, etc. Other parameters may also be adjustable in some cases.

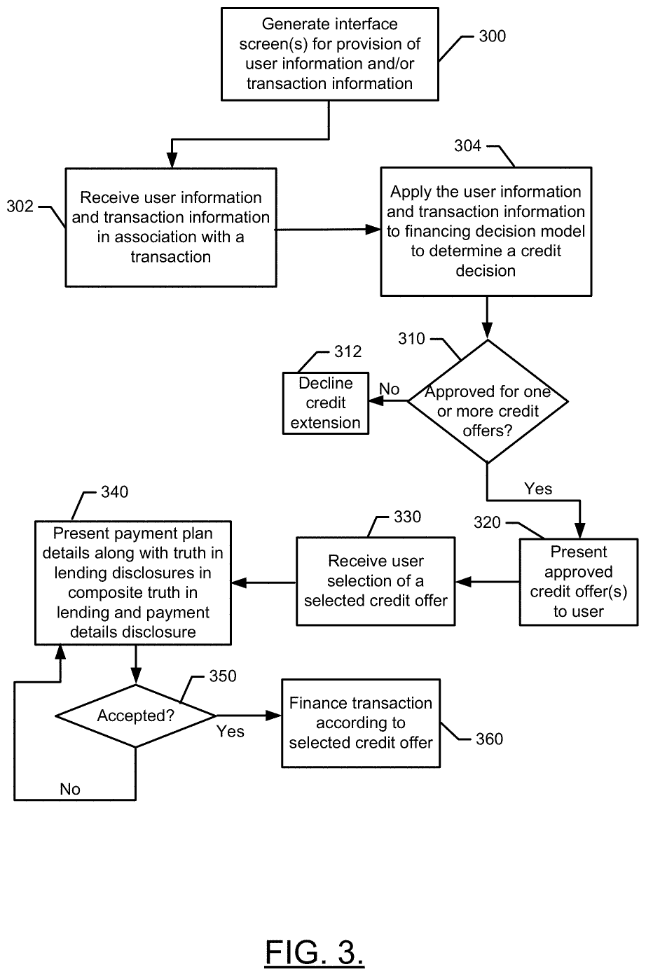

FIG. 3 illustrates a block diagram showing control flow associated with operation of the credit extension platform 50 and interface generation module 80 in accordance with an example embodiment. As shown in FIG. 3, one or more interface screens may be generated for soliciting provision of user information and/or transaction information at operation 300. Operation 300 may be accessed in a separate workflow associated with proceeding to a vendor's online checkout in some cases, and may be accessed via a link for financing in some cases. However, other ways of landing in the workflow of FIG. 3 are also possible.

Thereafter, user information may be received (in some cases along with transaction information) in association with a transaction at operation 302. The user information may be information that identifies a user account, or information that can be used for setting up the user account. The transaction information may identify the vendor or merchant associated with the product or service that is the subject of the transaction, the product or service itself, and/or any other useful information associated with the vendor/merchant or the product/service that may be useful in connection with the operation of the credit extension platform 50 (e.g., machine learnable data that may inform how to tailor options or form and structure of messaging to the user). Thereafter, various underwriting rules and policies may be employed along with the corresponding model information for each respective type of financing option to determine whether the user is qualified to receive a credit offer. This may be accomplished by running a financing decision model to determine credit extension decisions for the user at operation 304. In this regard, for example, operation 304 may include applying the user information and transaction information to a loan decision model to determine a loan credit decision (e.g., based on the underwriting policies and rules for corresponding loans).

A decision regarding continued workflow processing may then be made at operation 310 based on whether the user is approved for one or more credit offers. If the user is not approved for any credit offers, then the user may be declined any extension of credit at operation 312. However, if the user is approved for at least one or multiple credit offers, then the control flow proceeds to operation 320. At operation 320, the credit offer (or offers) may be presented to the user for selection of an offer to apply for completion of the transaction at checkout. In this context, the checkout may be a virtual or physical checkout, where the user attempts to purchase an item or service from a vendor via using funds obtained by credit from the entity that operates the credit extension platform 50. A user selection of one of the credit offers (or the presented credit offer) may thereafter be received at operation 330, thereby making any credit offer that is selected by the user a “selected credit offer.”

At operation 340, the user may be presented with payment plan details along with truth in lending (or other required/legal) disclosures in a composite disclosure (e.g., a composite truth in lending and payment details disclosure. If the truth in lending disclosure is acknowledged as being reviewed and accepted at operation 350, and the payment plan is also accepted (both of which can be handled via a single final confirmation), then the transaction may be financed according to the selected credit offer at operation 360. In this regard, the loan may be underwritten and the corresponding repayment schedule associated with the confirmation of the loan may be applicable. A new phase may then be entered, which may include post checkout and the loan repayment period. However, if the composite disclosure is not accepted, workflow may return to operation 340 where payment plan options can be reviewed to determine if another option is preferable to the user.

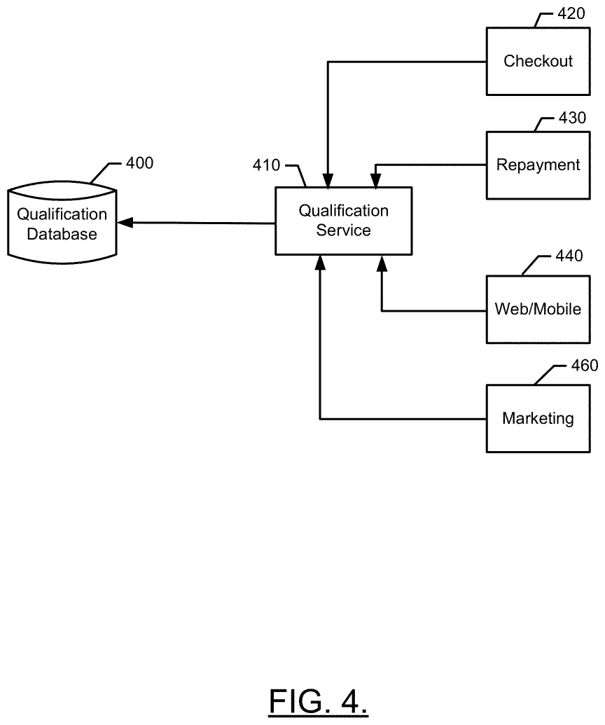

The method of FIG. 3 and the hardware described in reference to FIG. 2 are merely examples of methods and hardware that could be employed to implement example embodiments. Moreover, in some cases, various services or systems may cooperate to practice example embodiments, and different combinations of hardware and software may be employed to implement such services and systems. FIG. 4 is a block diagram of various systems interactions that may be employed to implement a user-level credit capability in accordance with an example embodiment.

As shown in FIG. 4, a qualification database 400 may store information associated with qualification (e.g., prequalification for existing user accounts, or qualification at checkout by setting up a user account during transaction processing) of a plurality of users, each having a corresponding user account setup and maintained as described above. In an example embodiment, the qualification database 400 may be a portion of the database server 44 of FIG. 1, or implemented in memory 104 of FIG. 2. The qualification database 400 may also store information associated with prior transactions for the users, vendors, products, etc., to enable machine learning to be conducted with respect to such information. A qualification service 410 may interface with and update the qualification database 400. The qualification service 410 may be implemented from the credit extension platform 50.

Checkout information may be provided to the qualification service 410 by various checkout systems 420 associated with respective different vendors or websites. Repayment information may also be provided to the qualification service 410 by various repayment systems 430 associated with respective different vendors or websites. Web or mobile devices 440 may be examples of clients 20 that may interact with the qualification service 410 to setup user accounts and to initiate transactions (via the checkout systems 420) or make payments (via the repayment systems 430). The qualification service 410 may handle all operations associated with operations 300 to 350 in FIG. 3 of the prequalification phase described above.

The qualification service 410 may be employed to make credit extension decisions described above. In some cases, the qualification service 410 may augment (or boost) credit limits based on machine learning. In some cases, the machine learning may be performed with respect to marketing information from a marketing system 460. Thus, for example, targeted promotions may be provided to selected users. Promotions, rebate offers, sale pricing and other marketing efforts may therefore be incorporated into the checkout processes for individual customers. Favorited items, or other behaviors exhibited by users that may show high interest in an item (or conversely activities that show low interest) may therefore be implemented on an adaptive basis to improve the quality of credit offers to potentially provide incentives for buying to the user. Merchant incentives may also be provided. Machine learning may also (e.g., based on past knowledge of user behavior or tendencies) provide a structure and form for credit offers that are targeted to the user. For example, if it is known (or can be learned through repeated interactions) that the user favors low interest options, no interest options, short or long terms, or other specific traits of credit offers that the user qualifies to receive, the qualification service 410 may tailor a smaller list of options to the user where the favored options are prominently (or only) displayed. In other words, personalized terms may be provided to users for the credit offers they receive.

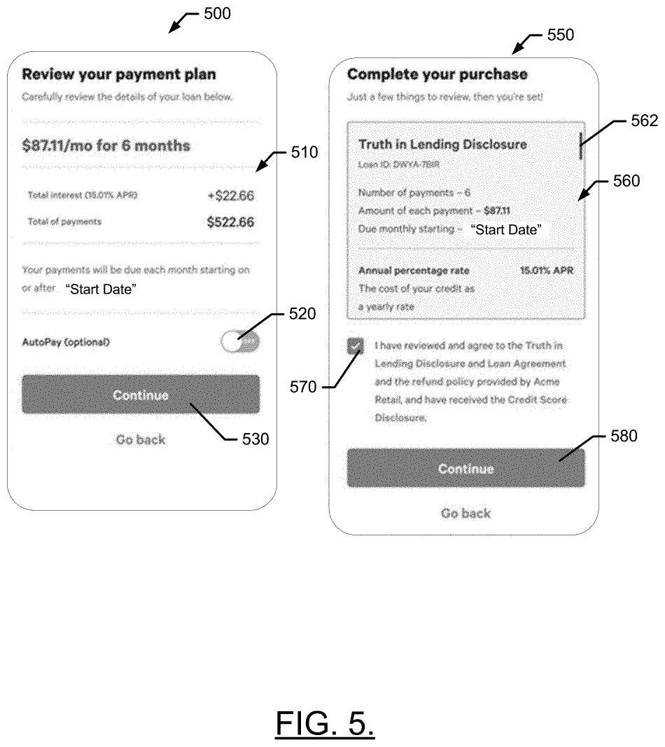

FIG. 5 illustrates an example of separate interface screens that may be used in some cases to provide review of payment plans separately from reviewing legal disclosures such as the truth in lending disclosure. In this regard, screen 500 shows payment terms 510 along with an option for automatic payment (e.g., autopay selector 520). By turning automatic payment on (e.g., via sliding the autopay selector 520 to “ON”) various options for automatic payment may be reviewed. Selection of a continue button 530 may not cause the transaction to be completed, but instead simply lead to further screens to review, such as a separate screen having the truth in lending disclosure therein.

For example, on a completely different interface screen, screen 550 may be used to provide required disclosures (e.g., the truth in lending disclosure). In this regard, a disclosure section 560 may be included on the screen, and may be too large to fit, so that a slide controller 562 is needed to enable sliding through the disclosure section 560 to review the whole thing. The user may select an acknowledgement 570 regarding review of the truth in lending disclosure, which acknowledgement 570 must be selected before the continue button 580 can be selected to process the transaction.

As noted above, the paradigm employed in FIG. 5 (i.e., two separate screens for payment plan terms and legal disclosures) can be confusing to some consumers. The presentation of terms within the screen 550 presenting the truth in lending disclosure are similar in content, but presented in a totally different way than those on the screen 500, which leads to consumer confusion. This confusion could potentially cause consumers to hesitate to complete the transaction for worry that they are missing something, which is the opposite intended effect. To address this issue, the composite disclosure mentioned above (e.g., of truth in lending (or legal/required disclosures) along with payment details is a consistent single display paradigm may be superior, and may lead to higher conversion rates and increased consumer understanding.

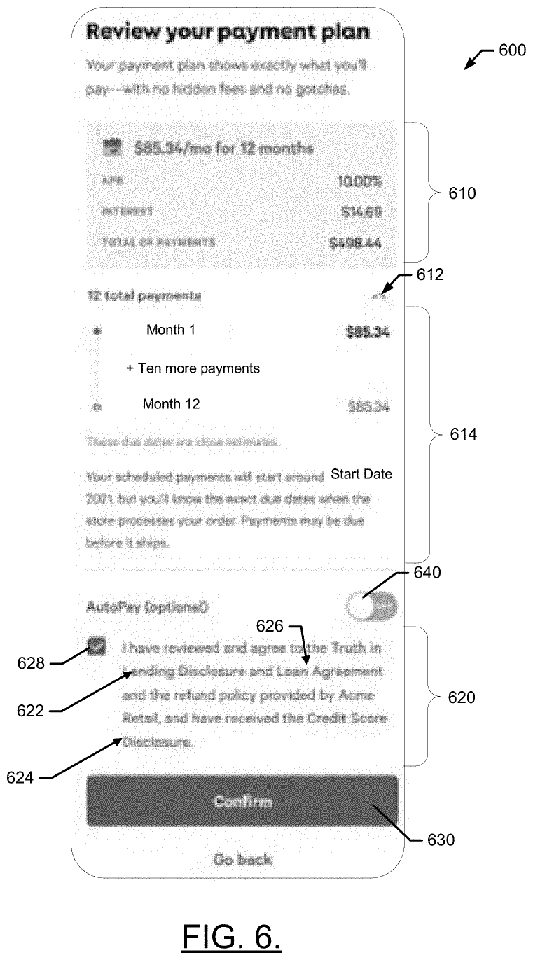

FIGS. 6-10 illustrate different expansion states, linkable pages, or modifications that may be available for a composite disclosure 600 in accordance with an example embodiment. In this regard, FIG. 6 illustrates the composite disclosure 600 in a state in which various expandable fields of the composite disclosure 600 are collapsed. Referring first to FIG. 6, the composite disclosure 600 includes payment plan details in a payment descriptor block 610 that includes expandable content accessible via an expansion selector 612. When the expansion selector 612 is selected, expansion section 614 is displayed to show individual payment amount breakdowns, and the number of payments associated with the selected credit offer, payment start dates, and dates of each payment, and any other suitable details regarding the payment plan associated with the selected credit offer. If the expansion selector 612 is selected again (i.e., when the expansion section 614 is displayed), the expansion section 614 will be collapsed and hidden from view until the expansion selector 612 is again selected.

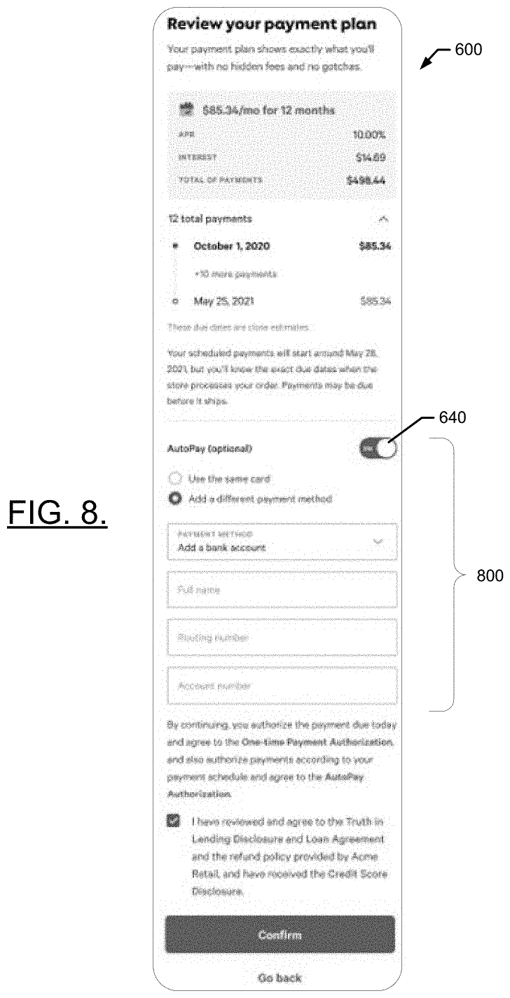

The composite disclosure 600 also includes a disclosure section 620 in which links to various required or legal disclosures may be provided. As an example of one such link, truth in lending disclosure link 622 is shown in FIG. 6, along with other links to a credit score disclosure 624 and a loan agreement 626. Selection of any of these links takes the user to the corresponding disclosure or agreement. An acknowledgement selector 628 may also be provided in the disclosure section 620 to (when selected) acknowledge review and acceptance of any agreements or disclosures in the disclosure section 620. The user may not be enabled to proceed to completing the transaction and securing the loan associated with the credit offer selected until the acknowledgement selector 628 has been selected and confirm button 630 has also been selected. An autopay selector 640 is also provided in the composite disclosure 600 to, when selected, provide an expansion section that is dedicated to automatic payment functions described in greater detail below in reference to FIG. 8.

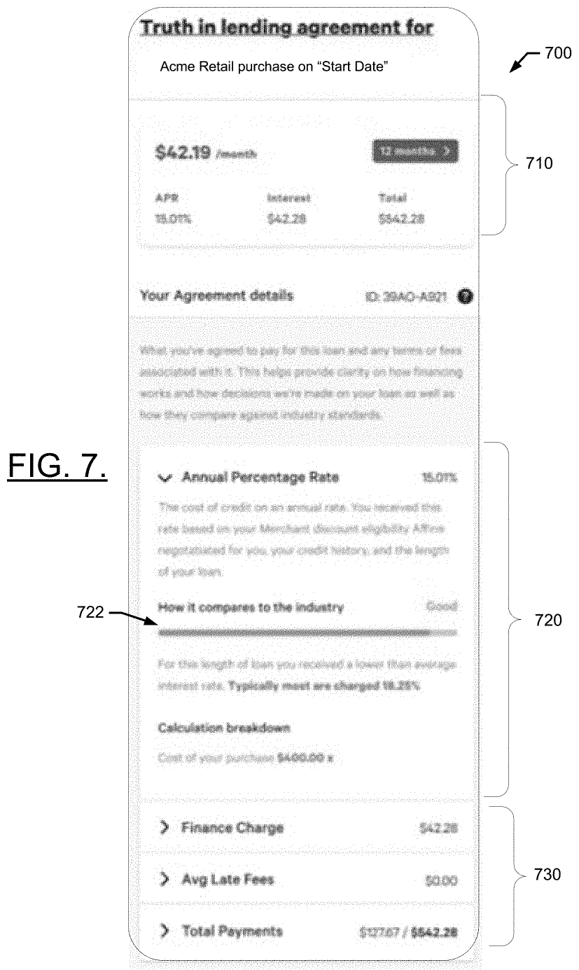

FIG. 7 illustrates a truth in lending disclosure 700 that may be reviewed responsive to selection of the truth in lending disclosure link 622 from FIG. 6. The truth in lending disclosure 700 includes a summary section 710, which describes the total amount financed, the total amount of interest paid, the monthly payment, the number of payments, and the interest rate (e.g., annual percentage rate (APR)). A collapsible detail section 720 for the APR may also be provided along with a graphic comparison display 722, which indicates how the APR for the credit offer selected compares to other loans in the industry, or industry averages. Other collapsible information sections 730 may include detailed information on the finance charge, average late fees, and total payments.

If the autopay selector 640 of FIG. 6 is selected, as shown in FIG. 8, an automatic payment expansion section 800 is displayed. The automatic payment expansion section 800 may be configured to extract information needed to support automatic payment functions. In this regard, for example, the automatic payment expansion section 800 may provide options for identifying bank information, routing numbers, account numbers, etc. to enable automatic payments to be extracted on schedule from the corresponding account identified therein.

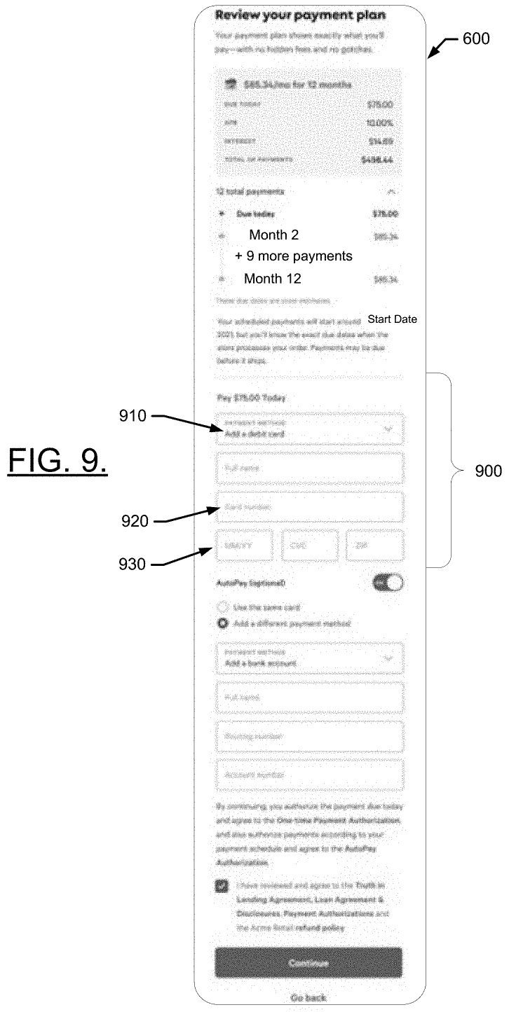

The contents (i.e., the fields) and functions of the composite disclosure 600 described above may be modified to support additional functions or changes in form. FIG. 9 illustrates an example in which terms of a credit offer may be modified in-process by the provision of a down payment. In this regard, a down payment section 900 is added to the contents of FIG. 8, and the down payment section 900 enables the user to select a payment method 910 (e.g., a debit card, credit card, or other payment method), and to provide details for account identification via various fields (e.g., card number field 920 and authorization information fields 930). By adding a down payment option, the user may be able to either qualify for loans that he/she would otherwise not qualify for, or may change the terms of the loan to reduce the financed amount, and therefore also reduce monthly payments to more desirable levels.

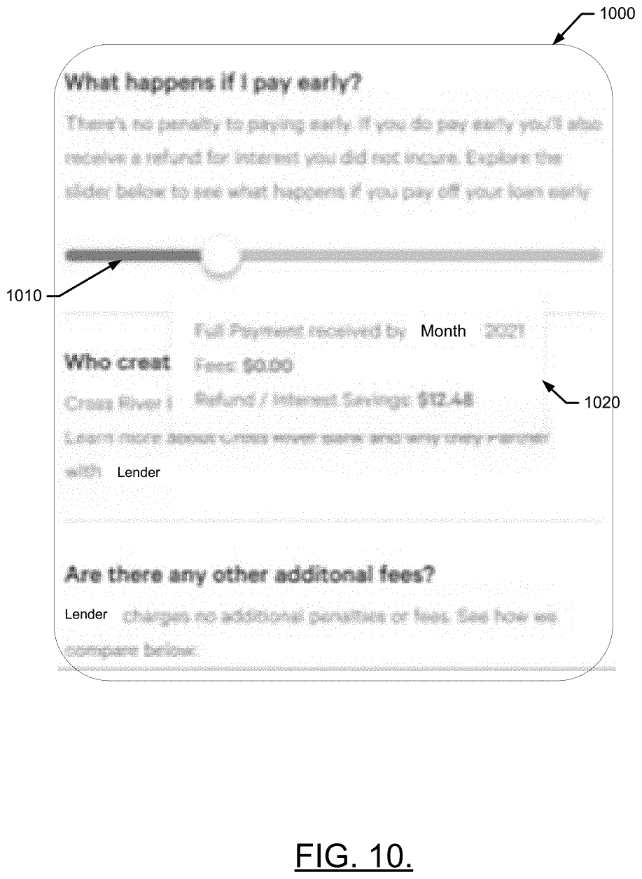

Other modifications to the composite disclosure 600 may also be provided in other alternative embodiments. For example, FIG. 10 illustrates a payment modification section 1000, which may be an expandable portion of the composite disclosure 600 of an alternative embodiment. The payment modification section 1000, which may be generated by the payment adjustment module 150 of FIG. 2 in some cases, may enable the user to accurately determine how payback of the loan may differ from terms of the credit offer via making adjustments to the payments otherwise prescribed in the credit offer. In this regard, for example, a slider bar 1010 may be provided to enable the user to slide to adjust a payment amount for making extra or early payments. An adjustment window 1020 may be generated to display the effects of employing the payment strategy defined by the slider bar 1010. Thus, for example, the user may experiment with different payment amounts or strategies in an effort to define further tailored adjustments to the payback of the loan while operating within the constructs of the original loan agreement.

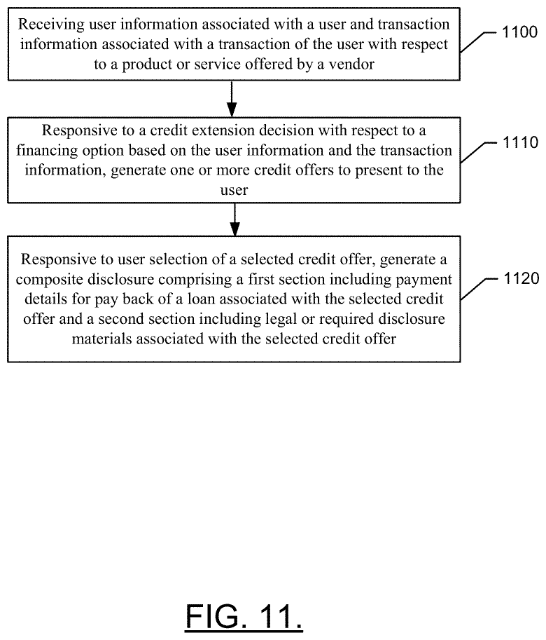

From a technical perspective, the credit extension platform 50 and/or client 20 described above may be used to support some or all of the operations described above. As such, the apparatuses described in FIGS. 2 and 4 may be used to facilitate the implementation of several computer program and/or network communication based interactions. As an example, FIG. 11 is a flowchart of a method and program product according to an example embodiment of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a user terminal (e.g., client 20, application server 40, and/or the like) and executed by a processor in the user terminal. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method for providing an interface to a user in relation to extension of a loan to the user is shown in FIG. 11. The method may include receiving user information associated with the user and transaction information associated with a transaction of the user with respect to a product or service offered by a vendor at operation 1100. The method may further include, responsive to a credit extension decision with respect to a financing option based on the user information and the transaction information, generating one or more credit offers to present to the user at operation 1110. The method may also include, responsive to user selection of a selected credit offer, generating a composite disclosure comprising a first section including payment details for pay back of a loan associated with the selected credit offer and a second section including legal or required disclosure materials associated with the selected credit offer at operation 1120.

In an example embodiment, an apparatus for performing the method of FIG. 11 above may comprise a processor (e.g., the processor 102) or processing circuitry configured to perform some or each of the operations (1100-1120) described above. The processor may, for example, be configured to perform the operations (1100-1120) by performing hardware implemented logical functions, executing stored instructions, or executing algorithms for performing each of the operations. In some embodiments, the processor or processing circuitry may be further configured for additional operations or optional modifications to operations 1100 to 1120.

In some embodiments, the method (and a corresponding apparatus or system configured to perform the operations of the method) may include (or be configured to perform) additional components/modules, optional operations, and/or the components/operations described above may be modified or augmented. Some examples of modifications, optional operations and augmentations are described below. It should be appreciated that the modifications, optional operations and augmentations may each be added alone, or they may be added cumulatively in any desirable combination. In this regard, for example, the legal or required disclosure materials include a truth in lending disclosure. In an example embodiment, the truth in lending disclosure may be accessible via selection of a link provided in the composite disclosure. In some cases, the legal or required disclosure materials may further include a second link to a loan agreement defining terms of the selected credit offer, and a third link to a credit score disclosure. In an example embodiment, the composite disclosure may include an acknowledgement selector to acknowledge review and acceptance of the truth in lending disclosure, and completion of the transaction may be disabled until the acknowledgement selector has been selected. In some cases, the composite disclosure may include a plurality of expandable sections that are compressed by default, and expanded responsive to selection of a corresponding expansion selector. In an example embodiment, one of the expandable sections may include an automatic payment section that, when expanded, provides an interface for the user to enter account details for an account from which automatic payment is authorized. Alternatively or additionally, one of the expandable sections may include an expansion to a payment descriptor block to show individual payment amount breakdowns. Alternatively or additionally, one of the expandable sections may include an early payment section that, when expanded, provides an interface for the user to enter proposed early payment amounts and see resulting modifications to loan repayment terms based on the early payment amounts. Alternatively or additionally, one of the expandable sections may include an down payment section that, when expanded, provides an interface for the user to enter information associated with making a down payment with respect to the transaction to reduce a borrowed amount of the loan.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A method for providing an interface to a user in relation to extension of a loan to the user, the method comprising:
receiving user information associated with the user and transaction information associated with a transaction of the user with respect to a product or service offered by a vendor;
responsive to a credit extension decision with respect to a financing option based on the user information and the transaction information, generating one or more credit offers to present to the user; and
responsive to user selection of a selected credit offer, generating a composite disclosure comprising a first section including payment details for pay back of a loan associated with the selected credit offer and a second section including legal or required disclosure materials associated with the selected credit offer.

2. The method of claim 1, wherein the legal or required disclosure materials include a truth in lending disclosure.

3. The method of claim 2, wherein the truth in lending disclosure is accessible via selection of a link provided in the composite disclosure.

4. The method of claim 3, wherein the legal or required disclosure materials further include a second link to a loan agreement defining terms of the selected credit offer, and a third link to a credit score disclosure.

5. The method of claim 3, wherein the composite disclosure comprises an acknowledgement selector to acknowledge review and acceptance of the truth in lending disclosure, and
wherein completion of the transaction is disabled until the acknowledgement selector has been selected.

6. The method of claim 1, wherein the composite disclosure comprises a plurality of expandable sections that are compressed by default, and expanded responsive to selection of a corresponding expansion selector.

7. The method of claim 6, wherein one of the expandable sections comprises an automatic payment section that, when expanded, provides an interface for the user to enter account details for an account from which automatic payment is authorized.

8. The method of claim 6, wherein one of the expandable sections comprises an expansion to a payment descriptor block to show individual payment amount breakdowns.

9. The method of claim 6, wherein one of the expandable sections comprises an early payment section that, when expanded, provides an interface for the user to enter proposed early payment amounts and see resulting modifications to loan repayment terms based on the early payment amounts.

10. The method of claim 6, wherein one of the expandable sections comprises an down payment section that, when expanded, provides an interface for the user to enter information associated with making a down payment with respect to the transaction to reduce a borrowed amount of the loan.

11. An apparatus for providing an interface to a user in relation to extension of a loan to the user, the apparatus comprising processing circuitry configured to:
receive user information associated with the user and transaction information associated with a transaction of the user with respect to a product or service offered by a vendor;
responsive to a credit extension decision with respect to a financing option based on the user information and the transaction information, generate one or more credit offers to present to the user; and
responsive to user selection of a selected credit offer, generate a composite disclosure comprising a first section including payment details for pay back of a loan associated with the selected credit offer and a second section including legal or required disclosure materials associated with the selected credit offer.

12. The apparatus of claim 11, wherein the legal or required disclosure materials include a truth in lending disclosure.

13. The apparatus of claim 12, wherein the truth in lending disclosure is accessible via selection of a link provided in the composite disclosure.

14. The apparatus of claim 13, wherein the legal or required disclosure materials further include a second link to a loan agreement defining terms of the selected credit offer, and a third link to a credit score disclosure.

15. The apparatus of claim 13, wherein the composite disclosure comprises an acknowledgement selector to acknowledge review and acceptance of the truth in lending disclosure, and
wherein completion of the transaction is disabled until the acknowledgement selector has been selected.

16. The apparatus of claim 11, wherein the composite disclosure comprises a plurality of expandable sections that are compressed by default, and expanded responsive to selection of a corresponding expansion selector.

17. The apparatus of claim 16, wherein one of the expandable sections comprises an automatic payment section that, when expanded, provides an interface for the user to enter account details for an account from which automatic payment is authorized.

18. The apparatus of claim 16, wherein one of the expandable sections comprises an expansion to a payment descriptor block to show individual payment amount breakdowns.

19. The apparatus of claim 16, wherein one of the expandable sections comprises an early payment section that, when expanded, provides an interface for the user to enter proposed early payment amounts and see resulting modifications to loan repayment terms based on the early payment amounts.

20. The apparatus of claim 16, wherein one of the expandable sections comprises an down payment section that, when expanded, provides an interface for the user to enter information associated with making a down payment with respect to the transaction to reduce a borrowed amount of the loan.
